(19) United States
(12) Patent Application Publication
(10) Pub. No.: US 2025/0320695 A1
(43) Pub. Date: Oct. 16, 2025

(54) AIR WATER GENERATOR

(71) Applicant: Aquam Air Water Ltd., Waterloo (CA)

(72) Inventor: Yu Kawasaki, Nagoya (JP)

(21) Appl. No.: 18/930,555

(22) Filed: Oct. 29, 2024

(30) Foreign Application Priority Data
Apr. 11, 2024 (JP) 2024-063850

(51) Int. Cl. E03B 3/28; B01D 53/26; C02F 1/28; C02F 1/44; C02F 1/68; C02F 9/00

(52) U.S. Cl. CPC E03B 3/28; B01D 53/261; B01D 53/265; C02F 9/00; C02F 1/283; C02F 1/441; C02F 1/688; C02F 2201/005; C02F 2209/006

(57) ABSTRACT

This device comprises a collection bottle for storing condensate water made from air, a cold water tank for storing drinking water, a discharge part for discharging drinking water, a switching part for switching the flow path of drinking water supplied from the cold water tank, and a control unit for controlling the switching part. The control unit enables controlling the switching part to drain at least some of the drinking water that has accumulated in at least part of the flow path from the cold water tank to the collection bottle for a predetermined time during discharge, and controlling the switching part to discharge drinking water from the discharge part after the predetermined time has elapsed.

### TECHNICAL FIELD

The embodiments disclosed herein relate to an air water generator for producing drinking water from water vapor in the air.

### INTRODUCTION

An air water generator is generally a device that obtains drinking water by cooling the air to condense the water vapor in the air into liquid water and filtering it through a filter. For example, JP Patent Publication No. 2014-224399-A discloses an air water generator with such a general mechanism. This type of air water generator has the advantage of being able to produce drinking water on its own, without the need for external water supply. Therefore, it can easily provide drinking water even when tap water is unavailable and external water supply is difficult, such as during a disaster.

On the other hand, bacteria and viruses, which are invisible to the naked eye, float in the air. These bacteria, viruses, and microorganisms are collectively called airborne bacteria, and they have the potential to cause health hazards to humans, making disinfection measures necessary. These airborne bacteria are included in the water that condenses at the same time as the water condenses, and it is difficult to remove them completely, even with a filter. The drinking water obtained through filtration may become contaminated with impurities, such as bacteria that proliferate due to the airborne bacteria, while it is stored in the tank or piping within the air water generator. Therefore, it is desirable that the drinking water stored in the air water generator is supplied in a state where as many impurities have been removed as possible when provided for drinking.

As an air water generator with a sterilization function, the webpage airlith.com describes a storage tank equipped with an ultraviolet lamp, in which the drinking water stored in the tank is irradiated with the lamp for sterilization.

### SUMMARY OF THE INVENTION

The air water generator described on the webpage airlith.com is solely for sterilizing the drinking water in the storage tank. However, in air water generators, it is customary to have piping installed as a flow path between the water storage tank and the water outlet. In this case, after discharging drinking water from the water outlet, a certain amount of water remains inside the piping. As time passes until the next discharge, bacteria may grow in the drinking water that remains in the piping, and there is a risk that the contaminated water could be discharged without being removed.

Provided is an air water generator that can discharge drinking water, where at least a portion of the drinking water stored in the flow path between the water storage tank and the water outlet, which may have been contaminated due to the proliferation of bacteria, is drained, so that only drinking water that is as uncontaminated as possible is discharged. This can be achieved by an inexpensive and simple method.

In one embodiment, an air water generator produces drinking water from air, comprising a water collection bottle that stores condensed water made from air, a cold water tank that stores drinking water, a water discharge part that discharges drinking water, a switching part that switches the flow path of the drinking water supplied from the cold water tank, and a control unit that controls the switching part, wherein the control unit, during water discharge, drains at least part of the drinking water stored in at least part of the flow path from the cold water tank to the switching part into the water collection bottle for a predetermined time, and after the predetermined time has elapsed, controls the switching part to discharge drinking water from the water discharge part.

A plurality of filters may be provided in at least part of the flow path that supplies the condensed water stored in the water collection bottle to the cold water tank.

The plurality of filters may include at least an activated carbon filter, a reverse osmosis membrane filter, and a bio-mineral filter.

The switching part may include a three-way solenoid valve, with at least part of the flow path connection from the cold water tank as an inlet, a flow path connection part connected to the water discharge part, and a flow path connection part connected to the water collection bottle as outlets.

The control unit may include a control board composed of at least a CPU, main memory, non-volatile memory, and an input/output interface.

A water purification filter may be provided in at least part of the flow path from the cold water tank to the switching part.

The water collection bottle and the plurality of filters may be configured to be removable from the front of the machine housing.

The water purification filter may include at least one or more of an activated carbon filter, filtration membrane filter, ceramic filter, ion exchange resin filter, or reverse osmosis membrane filter.

A hot water tank may be provided for producing and storing hot water by heating at least part of the flow path from the cold water tank to the switching part.

An ultraviolet lamp may be provided to irradiate the drinking water stored in the cold water tank.

Provided herein is a method of providing drinking water from an air water generator as also described herein.

In an embodiment, the method includes storing water condensed from air in a water collection bottle, transferring the water from the water collection bottle to a cold water tank to be stored as drinking water, discharging the drinking water from a water discharge part, wherein discharging the drinking water includes controlling, by a control unit, a switching part to switch a flow path of the drinking water, wherein the flow path connects the cold water tank to the water discharge part and the water collection bottle through the switching part, wherein during water discharge the control unit controls the switching part to drain at least part of the drinking water stored in at least part of the flow path from the cold water tank to the switching part into the water collection bottle for a predetermined time and after the predetermined time has elapsed, controls the switching part to discharge drinking water from the water discharge part.

A plurality of filters may be provided in at least part of the flow path that supplies the condensed water stored in the water collection bottle to the cold water tank, and the method further comprises filtering the water which is transferred between the water collection bottle and the cold water tank. The plurality of filters may include any one of an activated carbon filter, a reverse osmosis membrane filter, and a bio-mineral filter.

The switching part may include a three-way solenoid valve, with at least part of the flow path connection from the cold water tank as an inlet, a flow path connection part connected to the water discharge part, and a flow path connection part connected to the water collection bottle as outlets.

The control unit may include a control board composed of at least a CPU, main memory, non-volatile memory, and an input/output interface.

A water purification filter may be provided in at least part of the flow path from the cold water tank to the switching part, wherein the method further comprises, during water discharge, filtering the drinking water which passes through the flow path between the cold water tank and the switching part. The water purification filter may include at least one or more of an activated carbon filter, filtration membrane filter, ceramic filter, ion exchange resin filter, or reverse osmosis membrane filter.

A heater may be provided to heat at least part of the flow path from the cold water tank to the switching part, wherein the method further comprises, during water discharge, heating the drinking water in the flow path between the cold water tank and the switching part.

An ultraviolet lamp may be provided to irradiate the drinking water stored in the cold water tank, wherein the method further includes irradiating the drinking water in the cold water tank.

The method may further comprise condensing water from the air by at least one of a refrigeration technique and an adsorption technique.

According to the present disclosure, it is possible to provide an air water generator that can discharge drinking water, where at least a portion of the drinking water stored in the flow path between the water storage tank and the water outlet, which may have been contaminated due to the proliferation of bacteria, is drained, so that only drinking water that is as uncontaminated as possible is discharged, and this can be achieved by an inexpensive and simple method.

### BRIEF DESCRIPTION OF THE DRAWINGS

FIG. 1 is a functional block diagram showing an example of the configuration of the air water generator according to an embodiment.

FIG. 2 is a diagram showing an example of the structure of the switching part in the air water generator according to an embodiment.

FIG. 3 is a diagram for explaining an embodiment of the air water generator according to an embodiment.

FIG. 4 is a diagram showing an example of the hardware configuration of the air water generator according to an embodiment.

FIG. 5 is a flowchart showing an example of the process flow according to an embodiment.

FIG. 6 is a diagram showing an example of the configuration of the three-way solenoid valve constituting the switching part.

FIG. 7 is a diagram showing an example of the appearance of the air water generator according to an embodiment.

FIG. 8 is a diagram showing an example of the appearance of the air water generator according to an embodiment.

FIG. 9 is a diagram showing an example of the structure of the water discharge part with a configuration that automatically switches the position of the discharge outlet over time.

FIG. 10 is a conceptual diagram showing an example of the structure of the water purification filter provided in the flow path between the water collection bottle and the cold water tank.

FIG. 11 is a conceptual diagram showing the state in which the condensed water is progressively purified as it sequentially passes through multiple connected water purification filters.

FIG. 12 is a conceptual diagram showing the relationship between water flow rate and water pressure.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

### Embodiment 1

The air water generator of Embodiment 1 includes a switching part for switching the flow path of drinking water supplied from the cold water tank, wherein when discharging water into a container such as a cup (hereinafter referred to as “cup, etc.”), at least part of the drinking water stored in at least part of the flow path from the cold water tank to the switching part is drained into a flow path different from the flow path used to discharge drinking water into the cup, etc., for a predetermined time from the start of the water discharge operation, and after the predetermined time has passed, water is discharged into the cup, etc.

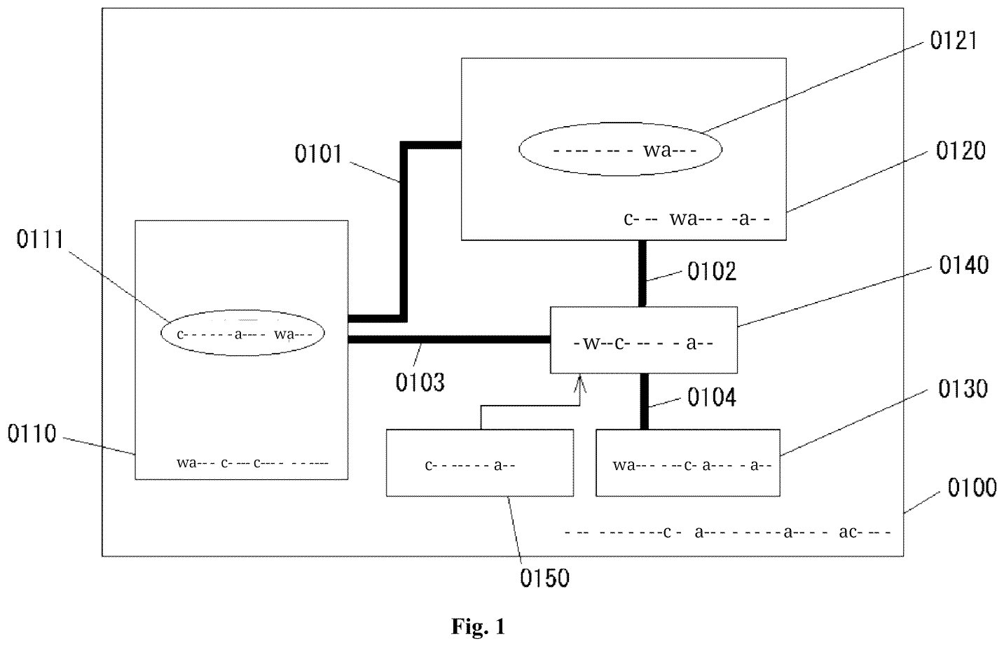

FIG. 1 is a functional block diagram showing an example of the configuration of the air water generator in Embodiment 1. The air water generator 0100 includes a water collection bottle 0110, a cold water tank 0120, a water discharge part 0130, a switching part 0140, and a control unit 0150.

In the present invention, an air water generator refers to a device that has the function of producing water from air and the function of supplying it to the user as drinking water. As is evident from this definition, the air water generator in the present invention needs to have at least the function of producing water from air and supplying it as drinking water to the user. In addition to this, devices that, for example, also have the function of setting a delivery water bottle containing drinking water to supply it to the user (a function that conventional water dispensers provide) are also included as air water generators in the present invention.

Known techniques can be used for producing water from air. Two known techniques are the refrigerant type and the adsorption type. The refrigerant type obtains water by using a refrigerant, such as a refrigerant coil, to cool the air and condense the water vapor in the air. On the other hand, the adsorption type obtains water by using an adsorbent, such as an adsorption filter, to absorb moisture from the air, then heating it with a heater to evaporate it, and cooling the evaporated water to condense it into water. Either or both methods may be included in the air water generator of the present invention. Furthermore, devices using methods other than refrigeration and adsorption may be included in the air water generator of the present invention.

There are no particular limitations on the dimensions or weight of the air water generator; it can be appropriately designed according to the purpose or use. For example, a small air water generator installed in homes or offices (with a daily supply capacity of about 20 liters) could have dimensions of approximately 400-450 mm in width×480-530 mm in depth×1250-1300 mm in height, and a weight of about 50-60 kg.

The water collection bottle is a bottle-shaped component that stores condensed water 0111 made from air. However, its shape is not limited to this. There are no particular limitations on its capacity, and it can be appropriately designed according to the intended use. For example, in the case of a small air water generator, a capacity of about 1.5 to 2.0 liters might be appropriate. It is preferable for the water collection bottle to be equipped with a water level sensor to prevent water from overflowing and leaking. In this case, for example, if the water level sensor detects that the water collection bottle is about to overflow with condensed water, it could emit a warning sound or flash a warning lamp to prompt the system to stop producing condensed water, or it could stop the refrigerant pump used for condensation. Additionally, the measurement results from the water level sensor could be displayed on a display located on the front of the air water generator's housing or elsewhere.

As will be described later, the water collection bottle also serves the role of a drainage destination when discharging all or part of the drinking water stored in the flow path prior to water discharge.

The cold water tank is a tank (water reservoir) for storing drinking water 0121 in a cold state. This drinking water is the condensed water stored in the water collection bottle and transferred via the flow path 0101. At that time, the cold water tank can maintain this state by receiving the supply of chilled condensed water, or it can chill the water inside the tank after receiving the water, and maintain it in a cold state. In the present invention, “cold water” refers to water between 0° C. and less than 10° C., with bacteria said to proliferate easily between approximately 10° C. and 60° C. Preferably, the water is between 0° C. and 5° C. The method for maintaining the cold state of the water can use known technologies, such as the refrigeration cycle technology employed in refrigerators. The shape of the cold water tank is not limited. Its capacity is also not particularly restricted and can be designed appropriately based on the intended use. For example, in the case of a small air water generator, a capacity of about 10 to 15 liters might be appropriate.

As described above, in the air water generator of this embodiment, a flow path 0101 is provided for transferring the condensed water stored in the water collection bottle to the cold water tank. In the present invention, several other flow paths are also provided. In the following description, for convenience and to distinguish it from other flow paths, this flow path between the water collection bottle and the cold water tank will be referred to as the “flow path between the water collection bottle and the cold water tank.”

The flow path is a tubular component for passing water. The dimensions and materials of the flow path between the water collection bottle and the cold water tank are not particularly limited. For example, in the case of a small air water generator, a silicone hose with an inner diameter of about 3 to 5 millimeters (a hose made of silicone rubber with a heat-resistant synthetic fiber layer sandwiched between) or a rigid hose (made of polyurethane, polyvinyl chloride, etc.), or a combination of these, can be used. The intake of condensed water into the flow path and its transfer to the cold water tank can be done using a pump, for example.

It is preferable for multiple water purification filters to be installed in this flow path between the water collection bottle and the cold water tank, to remove bacteria, fine debris, or to add necessary minerals. This is to purify the condensed water and make it suitable for drinking. This configuration will be described in another embodiment (refer to Embodiment 2).

The drinking water stored in the cold water tank is typically supplied to the user as drinking water by being discharged through the water discharge part via a flow path separate from the flow path between the water collection bottle and the cold water tank. Therefore, the air water generator of this embodiment includes a flow path between the cold water tank and the water discharge part.

The flow path between the cold water tank and the water discharge part has a switching part installed along the way. This switch is configured to drain potentially contaminated drinking water into the water collection bottle first, and then send uncontaminated drinking water to the water discharge part. In the following explanation, for convenience and to distinguish between different flow paths, the flow path from the cold water tank to the switching part will be referred to as the “flow path between the cold water tank and the switching part” 0102, the flow path from the switching part to the water collection bottle will be referred to as the “flow path between the switching part and the water collection bottle” 0103, and the flow path from the switching part to the water discharge part will be referred to as the “flow path between the switching part and the water discharge part” 0104. The assumption that the water in the flow path between the cold water tank and the switching part might be contaminated is based on the fact that the water in this flow path is not cooled within the flow path, nor is it sterilized by ultraviolet light or heat, allowing any bacteria present to possibly multiply. The dimensions and materials of these flow paths are not particularly limited, but for example, in the case of a small air water generator, the flow path between the cold water tank and the switching part may use a combination of silicone hoses with inner diameters of about 8-15 millimeters, 7-11 millimeters, and 3-5 millimeters. For the flow path between the switching part and the water collection bottle, a rigid hose with an inner diameter of about 3-5 millimeters may be used, and for the flow path between the switching part and the water discharge part, a silicone hose with an inner diameter of about 8-15 millimeters may be used.

A characteristic of the air water generator in this embodiment is that when discharging drinking water, instead of directly discharging the water stored in the flow path between the cold water tank and the switching part 0102 (which may contain impurities like bacteria that have multiplied over time), this water is first drained into the water collection bottle, and then uncontaminated drinking water is replenished from the cold water tank, allowing uncontaminated water to be discharged. That is, when discharging water, the air water generator in this embodiment operates as follows: (1) First, for a predetermined time, all or part of the drinking water stored in the flow path between the cold water tank and the switching part is drained into the water collection bottle. Along with this, fresh drinking water is replenished from the cold water tank into the flow path between the cold water tank and the switching part. The supply of new drinking water from the cold water tank into the flow path between the cold water tank and the switching part can be done using a pump provided in the flow path, for example. Alternatively, the flow path between the cold water tank and the switching part can be installed vertically directly below the cold water tank, with a check valve provided at the exit portion of the cold water tank into the flow path, so that, along with the drainage, the water pressure in the cold water tank automatically opens the valve, and the drinking water in the cold water tank is supplied into the flow path by free fall.

The reason for including the case where “part” of the drinking water stored in the flow path between the cold water tank and the switching part is drained into the water collection bottle is that, for example, some water may remain in the water purification filter or in the gaps at pipe joints within the flow path, and may not be drained. In other words, it is assumed that, due to the structural characteristics of the flow path between the cold water tank and the switching part, only part of the drinking water stored in this flow path may be drained into the water collection bottle. However, even in such a case, the residual amount is considered to be minimal. Therefore, the effect of the present invention, which ensures that only uncontaminated drinking water is discharged from the water discharge part after performing drainage for a predetermined time, can still be sufficiently achieved. Accordingly, the present invention includes within its technical scope a configuration where only partial drainage is performed.

As described above, (1) after the drinking water in the flow path between the cold water tank and the switching part is drained into the water collection bottle, the air water generator of this embodiment next (2) discharges only the drinking water that has been newly replenished from the cold water tank after the predetermined time has elapsed (if there is residual water as mentioned above, the newly replenished water from the cold water tank is added to the residual water, and this combined water is discharged). This allows for the discharge of drinking water that is as uncontaminated as possible.

If water remains in the flow path between the switching part and the water discharge part after the water discharge is completed, there is a risk that the remaining water will become contaminated and will be discharged from the water discharge part during the next water discharge. While the effect of the present invention, which ensures that only uncontaminated drinking water is discharged, can still be sufficiently achieved, it is more desirable for the air water generator according to the present invention to be configured such that no water remains in the flow path between the switching part and the water discharge part after water discharge is completed. For example, one possible configuration is to install the flow path between the switching part and the water discharge part vertically directly below the switching part, so that the drinking water in the flow path can drain completely by free fall, preventing any water from remaining. In this case, to prevent water from remaining in the flow path due to capillary action, it is preferable to make the diameter of the flow path sufficiently large, for example, between 8 and 15 millimeters, as previously mentioned. If the diameter is smaller than 8 millimeters, water may remain in the flow path due to capillary action, while if the diameter is larger than 15 millimeters, the force of the water discharged into the cup may be too strong, potentially causing a paper cup to tip over or splashing water around the cup when it is nearly full. Alternatively, a configuration that automatically switches the position of the water discharge outlet over time can be used. This ensures that even if water remains in the flow path between the switching part and the water discharge part, the drinking water that may be contaminated is not discharged for drinking purposes.

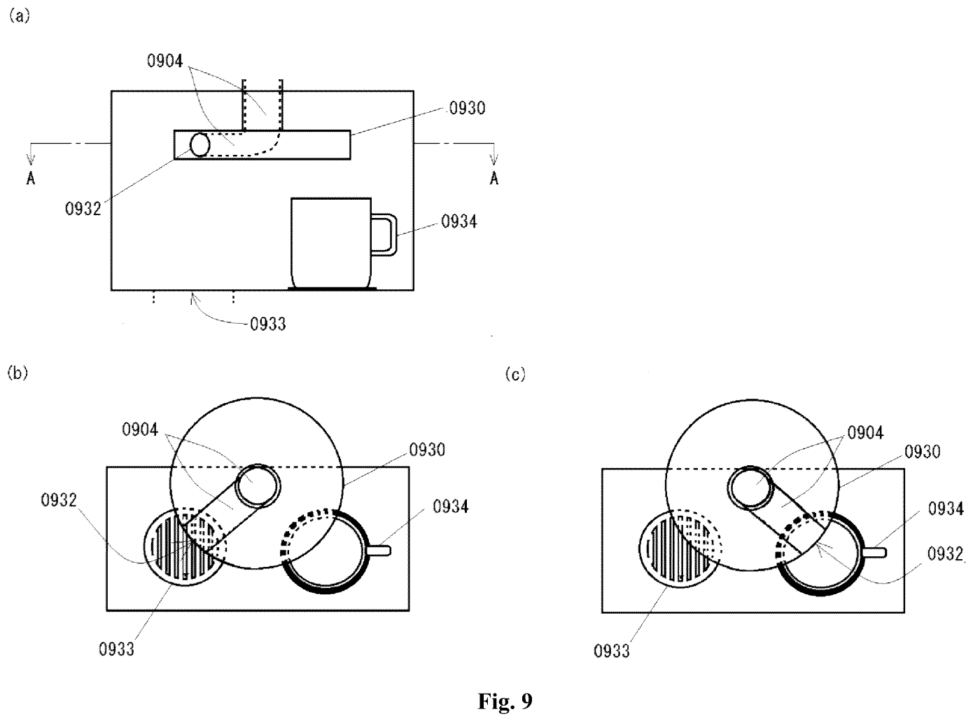

FIG. 9 shows an example of the structure of the water discharge part with a configuration that automatically switches the position of the water discharge outlet over time. In this example, the direction of the water discharge outlet 0932, located on the side of the disk-shaped water discharge part 0930, can be switched between the direction where a cup 0934 is placed and the direction where no cup is placed. In the figure, (a) is a front view of the vicinity of the water discharge part of the air water generator, and (b) is a cross-sectional view along line A-A. After the water discharge part is operated and the water in the flow path between the cold water tank and the switching part is discharged for a predetermined time, the water supply to the flow path between the switching part and the water discharge part begins. For a certain period of time, the water discharge outlet 0932 is directed toward the side where no cup is placed, as shown in (b) (the discharged water is drained through the drain 0933). After a certain period of time, the direction of the water discharge outlet is automatically switched to the side where the cup is placed, as shown in (c), and drinking water is poured into the cup. Such a configuration can be implemented using known techniques (for example, by providing a motor capable of reversing a disk-shaped member and controlling the motor to reverse it based on time using a computer).

The water discharge part is configured to discharge drinking water. This discharge is performed as a supply of drinking water to the user. The specific configuration and structure of the water discharge part are not particularly limited. For example, configurations where drinking water is discharged from the spout when a lever is pressed or pushed by a cup, or where the water is discharged when a button is pressed by hand, can be considered. For instance, if the switching part is a three-way valve, in the case of a button-operated type, when the user presses the button, the valve connecting the flow path between the switching part and the water collection bottle opens, and after the water in the flow path between the cold water tank and the switching part is drained to the water collection bottle for a predetermined time, the valve connecting the flow path between the switching part and the water discharge part opens in place of the previous valve, and water is discharged into the cup. After a certain period of time (for example, the time it takes to fill a cup with drinking water to its full capacity), the valve connecting the flow path between the switching part and the water discharge part automatically closes, ending the discharge. In the case of a lever-operated type, where the lever is pressed by the cup, the valve connecting the flow path between the switching part and the water collection bottle opens while the lever is pressed, and after the water in the flow path between the cold water tank and the switching part is drained to the water collection bottle for a predetermined time, the valve connecting the flow path between the switching part and the water discharge part opens, discharging water into the cup. When the user stops pressing the lever, the valve closes, ending the discharge. If there are multiple types of drinking water (e.g., hot water and cold water), the water discharge part may be equipped with multiple spouts to accommodate this.

Prior to this discharge, the drinking water in the flow path between the cold water tank and the switching part is sent to the water discharge part via the flow path between the switching part and the water discharge part. As described above, the drinking water in the flow path between the cold water tank and the switching part is mostly or entirely replaced by uncontaminated drinking water newly supplied from the cold water tank after most or all of the previous water has been drained into the water collection bottle. That is, if all of the drinking water in the flow path between the cold water tank and the switching part is drained, it will be entirely replaced by uncontaminated drinking water newly supplied from the cold water tank. On the other hand, even if some water remains due to the structural characteristics of the flow path between the cold water tank and the switching part, most of the path will still be filled with uncontaminated drinking water newly supplied from the cold water tank. Furthermore, if the amount of water discharged exceeds the volume of the flow path between the cold water tank and the switching part, additional drinking water will be replenished from the cold water tank during discharge and will be discharged through the flow path between the switching part and the water discharge part. Therefore, in all cases, it is possible to discharge drinking water that is as uncontaminated as possible.

As a way to enable the switching of such flow paths, the air water generator is equipped with a switching part 0140 and a control unit 0150.

The switching part is configured to switch the flow path of the drinking water supplied from the cold water tank. Specifically, the switching part serves as the way to switch the destination of the drinking water in the flow path between the cold water tank and the switching part 0102, either to the water collection bottle or to the water discharge part. A specific example of such a way is the use of a three-way valve. A three-way valve is a valve-like component that has three connection points (one inlet and two outlets) to connect to the flow path or piping, and it can switch the destination of the fluid by opening and closing the valves at the outlets. In the switching part of this embodiment, the connection point to the flow path from the cold water tank 0102 serves as the inlet, while the connection points to the flow path between the switching part and the water collection bottle 0103 and the flow path between the switching part and the water discharge part 0104 serve as the outlets.

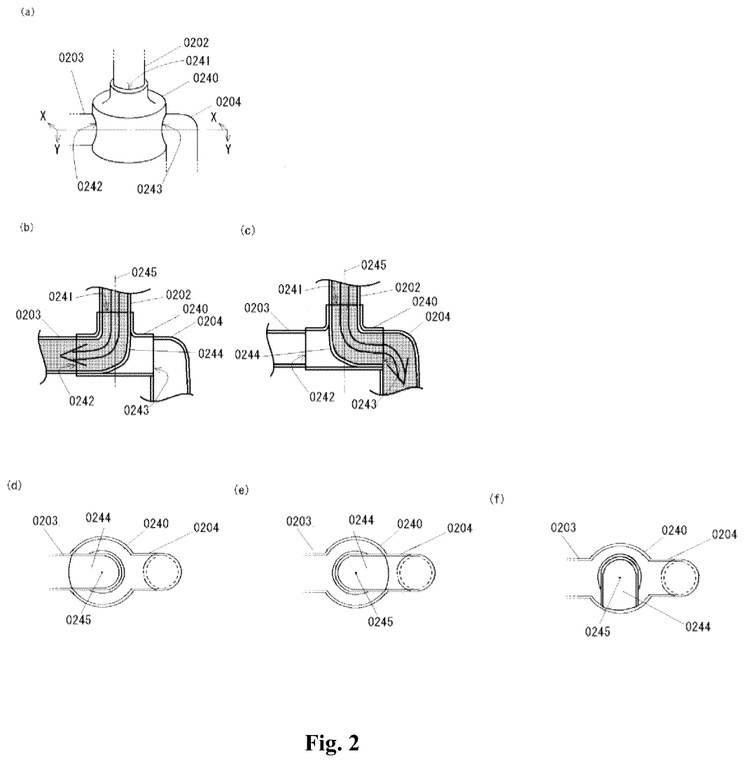

FIG. 2 shows an example of the structure of the switching part in the air water generator of Embodiment 1, where the switching part is a three-way valve. In FIG. 2, (a) is a perspective view showing an example of the external appearance of the switching part, which has an inlet 0241 connected to the flow path between the cold water tank and the switching part 0202, and two outlets 0242 and 0243 connected to the flow paths between the switching part and the water collection bottle 0203 and the switching part and the water discharge part 0204, respectively. (b) and (c) are vertical cross-sectional views along line Y-Y of (a). As shown in these figures, inside the body of the switching part 0240, there is a roughly L-shaped tubular component (hereinafter referred to as the “L-tube”) 0244, which can only connect to one of the outlets at a time. The L-tube is configured to rotate horizontally around the central axis 0245 of the flow path between the cold water tank and the switching part, allowing it to switch the direction of water flow to either the water collection bottle or the water discharge part by rotating the outlet end of the L-tube. In (b), the state is shown for the period after the water discharge mechanism has been operated, but before a predetermined amount of time has passed (before the water discharge mechanism is operated, the state is as shown in (f), described later). The L-tube 0244 is connected to the flow path between the switching part and the water collection bottle 0203, and the water in the flow path between the cold water tank and the switching part 0202 is being drained into the flow path between the switching part and the water collection bottle (the water present in the flow path between the cold water tank and the switching part, the L-tube, and the flow path between the switching part and the water collection bottle is shown in light gray, and the direction of the water flow is indicated by arrows). Next, in (c), after the predetermined time has passed, the L-tube rotates horizontally to connect to the flow path between the switching part and the water discharge part 0204, and the water in the flow path between the cold water tank and the switching part is being supplied to the flow path between the switching part and the water discharge part (again, the water present in the flow path between the cold water tank and the switching part, the L-tube, and the flow path between the switching part and the water discharge part is shown in light gray, with arrows indicating the direction of the water flow). (d) to (f) are horizontal cross-sectional views along line X-X of (a). (d) shows the same state as (b), where the water discharge mechanism has been operated, but the predetermined time has not yet passed, and (e) shows the same state as (c), after the predetermined time has passed. (f) shows the state after the water discharge has been completed and until the next time the water discharge mechanism is operated. In this state, the L-tube is not connected to either outlet, meaning the water in the flow path between the cold water tank and the switching part is neither drained into the water collection bottle nor supplied to the water discharge part, and remains in place.

The specific type of switching valve is not limited and may be either mechanical or electromagnetic. For example, a preferred example is a three-way solenoid valve. The three-way solenoid valve will be described later in another embodiment (refer to Embodiment 4). The components that make up such a switching part generally have a simple structure, are inexpensive to install, and have the advantage of being more cost-effective compared to installing ultraviolet lamps or heaters for obtaining high-temperature water.

The switching operation of the switching part described above is entirely controlled by the control unit, which will be described next.

The control unit is configured to control the switching part. More specifically, the control unit is configured to control the switching part such that, during water discharge, at least part of the drinking water stored in at least part of the flow path from the cold water tank to the switching part is drained into the water collection bottle for a predetermined time, and after the predetermined time has passed, drinking water is discharged from the water discharge part. In other words, when supplying drinking water through the water discharge part, the control unit first controls the opening of the switching part to the water collection bottle side (the flow path between the switching part and the water collection bottle) so that all or part of the water stored in the flow path between the cold water tank and the switching part is drained into the water collection bottle for a predetermined time. After the predetermined time has passed, the control unit then switches the opening of the switching part to the water discharge part side (the flow path between the switching part and the water discharge part) so that the water in the flow path between the cold water tank and the switching part can be discharged from the water discharge part via the flow path between the switching part and the water discharge part.

The “predetermined time” should be appropriately determined as a design matter, based on factors such as the time required to drain the potentially contaminated water stored in the flow path between the cold water tank and the switching part into the water collection bottle. For example, if the calculated time required to drain almost all of the drinking water from the flow path, based on the volume of the flow path and the drainage capacity of the pump per unit of time, is 5 seconds, it might be suitable to set the “predetermined time” uniformly to 5 seconds.

Alternatively, from the perspective of minimizing the amount of drinking water drained into the water collection bottle without being discharged, it is possible to take into account that the degree of contamination may vary depending on how long the drinking water has been sitting in the flow path. If the water has been sitting in the flow path for a short time, it may not be necessary to drain all the water into the water collection bottle (in other words, even if some residual water remains, it may still be suitable for drinking if it is sufficiently diluted with uncontaminated water that is newly supplied). In such cases, the “predetermined time” mentioned above could be adjusted according to the retention time, for example, setting it to 1 second if the retention time is less than 3 hours, 3 seconds if the retention time is between 3 and 6 hours, and 5 seconds if the retention time is between 6 and 9 hours. In this case, the retention time could be determined by using a clock function provided in the air water generator or an external device to record the time history of water discharge operations.

According to the air water generator of this embodiment described above, it is possible to discharge only drinking water that is as uncontaminated as possible simply by switching the flow paths. There is no need to install equipment such as a UV lamp for sterilization or a heater to produce hot water. Therefore, the goal of discharging only uncontaminated drinking water can be achieved through a simple and cost-effective method.

Although not included in the technical scope of the present invention, in cases where the next water discharge operation is performed very shortly after the previous one, it may be possible to skip the drainage to the water collection bottle entirely and discharge the water immediately, with the “predetermined time” effectively set to zero. This is because, in such cases, it is clear that the drinking water in the flow path between the cold water tank and the switching part has not been contaminated.

The present invention is fundamentally an invention that utilizes a computer and can be implemented via software, hardware, or a combination of both. The hardware that realizes all or part of the constituent elements of the present invention includes at least the CPU, main memory, non-volatile memory, and input/output interfaces as part of the basic components of a computer.

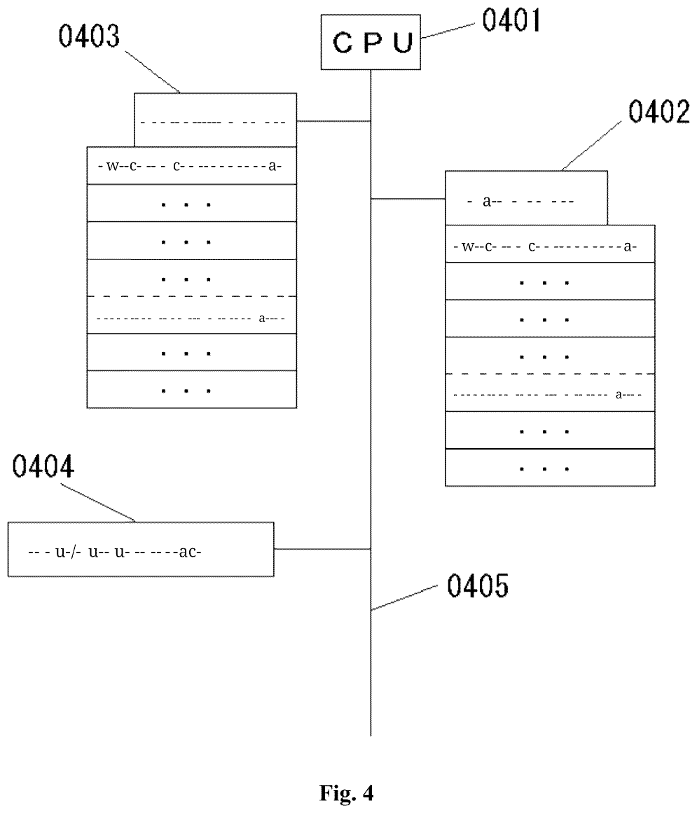

FIG. 4 shows an example of the hardware configuration of the air water generator in Embodiment 1. The air water generator 0400 includes a CPU 0401, main memory 0402, non-volatile memory (e.g., a hard disk drive (HDD), solid-state drive (SSD), etc.) 0403, and an input/output interface 0404. These components are interconnected via a bus line 0405, which serves as the data communication path, enabling the sending, receiving, and processing of information.

The present invention can fundamentally be composed of a general-purpose computer program and various devices. The computer operates by loading programs stored in non-volatile memory into main memory when triggered by events such as powering on the system. Processing is carried out between the main memory, CPU, and various devices. Communication with devices occurs through the input/output interface connected to the bus line. Examples of input/output interfaces include a mouse, keyboard, and display interface.

The CPU (central processing unit) sequentially reads, interprets, and executes instructions, which are programs stored in the main memory, outputting information in the form of signals to the main memory. The CPU functions as the core of computation within the computer. The CPU includes the core part, which performs calculations, and its surrounding components. Inside the CPU, there are registers, cache memory, an internal bus connecting the cache memory and CPU core, a direct memory access (DMA) controller, a timer, and an interface with the bus that connects to the northbridge. Additionally, the CPU may have multiple cores within a single CPU (chip). Furthermore, processing can also be performed using a graphics processing unit (GPU) or a floating-point unit (FPU), in addition to the CPU. Programs can also be built into the CPU itself.

In this embodiment, the CPU executes the flow path switching control program loaded into the main memory, which controls the switching of the flow path. This switching control program is designed to receive a signal indicating that an operation for discharging drinking water (e.g., pressing a lever) has been performed, and then open the connection port to the water collection bottle side of the switching part while closing the connection port to the water discharge part. After a predetermined time has passed, it closes the connection port to the water collection bottle side and opens the connection port to the water discharge part. Non-volatile memory stores information such as the predetermined time (e.g., set to 5 seconds), which is also loaded into the main memory upon receiving a command to start the program. To execute the switching control program, the CPU needs to know when the predetermined time has elapsed. The CPU can do this by comparing the predetermined time information, which is loaded into the main memory, with time information retrieved from a clock (timekeeping device) connected through the input/output interface (which is also loaded into the main memory).

The main memory reads out programs to be executed by the CPU and simultaneously provides a work area for these programs, which serves as a workspace. The main memory is volatile memory, typically using dynamic random-access memory (DRAM). Programs stored in the main memory are loaded from non-volatile memory, for example, when a program start command is received. The CPU directly accesses the main memory to execute various programs stored there. During the execution, the CPU continues to process commands and follow the execution steps of the program.

Additionally, both the main memory and non-volatile memory have multiple assigned addresses, allowing the CPU to access specific addresses to exchange data between the two, facilitating processing tasks.

In this embodiment, as mentioned earlier, the switching control program is loaded into the main memory from non-volatile memory when triggered by events such as powering on the system. Similarly, predetermined time information stored in non-volatile memory is also loaded into the main memory when a command to start the program is issued.

The non-volatile memory stores the switching control program and predetermined time information, as mentioned above, and these are loaded into the main memory when triggered by events such as powering on the system.

The input/output interface is connected to external devices and transmits received signals to the CPU via the bus line. An example of an external device in this embodiment is a clock used to provide predetermined time information. Additionally, buttons (which send a signal when pressed during water discharge) and displays (which show measurement data, such as the water level in the water collection bottle) are also possible external devices.

Next, the process flow related to the control by the control unit of the switching part in the air water generator of this embodiment will be described.

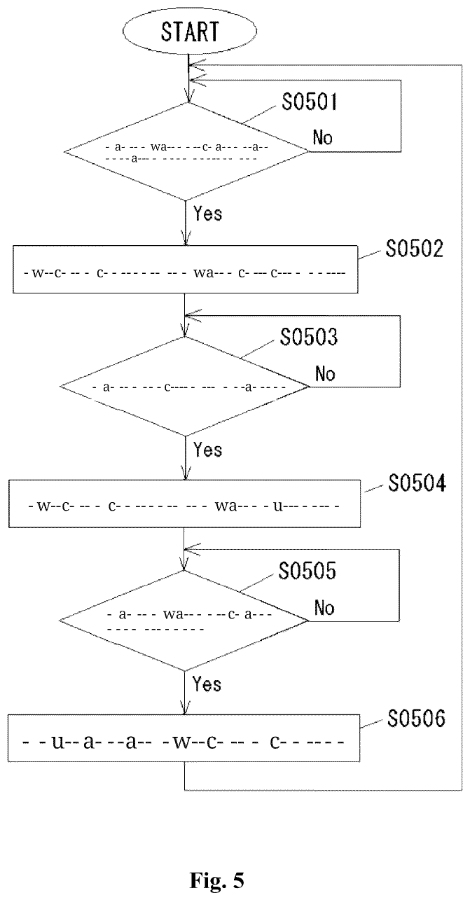

FIG. 5 is a flowchart showing an example of the process flow in Embodiment 1, specifically illustrating the process flow related to the control of the switching part by the control unit. As shown in the figure, in the judgment step S0501, the control unit determines whether the operation to start water discharge (discharge start operation) has been performed. If the control unit determines that the discharge start operation has been performed, the control unit executes the switching control to the water collection bottle side in step S0502, where the control unit controls the switching part to open the connection port to the water collection bottle side and close the connection port to the water discharge part. The judgment of whether the discharge start operation has been performed is made based on criteria such as whether the discharge button was pressed or the lever was pushed.

Next, in judgment step S0503, the control unit determines whether the predetermined time has elapsed. If the control unit determines that the predetermined time has elapsed, the control unit executes the switching control to the water discharge part in step S0504, where the control unit controls the switching part to close the connection port to the water collection bottle side and open the connection port to the water discharge part.

Furthermore, in judgment step S0505, the control unit determines whether the operation to stop water discharge (discharge stop operation) has been performed. If the control unit determines that the discharge stop operation has been performed, the control unit executes the switching control to the neutral state in step S0506, where the control unit controls the switching part to close the connection port to the water discharge part and keep the connection port to the water collection bottle side closed as well. In other words, the L-shaped tube of the switching part is not connected to either the flow path between the switching part and the water collection bottle or the flow path between the switching part and the water discharge part (this is referred to as the neutral state), as shown in FIG. 2(f). The judgment of whether the discharge stop operation has been performed is made based on criteria such as whether a certain amount of time has passed since the button was pressed, or whether the lever was released after being pressed. As a result, after the water discharge is completed, the L-shaped tube of the switching part remains in the neutral state, and under this condition, the control process will return to the judgment step to determine whether the next discharge start operation has been performed.

With the invention of this embodiment, it is possible to provide an air water generator that prevents potentially contaminated drinking water, stored in the flow path between the storage tank and the water discharge outlet, from being discharged as-is. By draining at least part of this water, the air water generator ensures that only drinking water that is as uncontaminated as possible is discharged. Furthermore, this system can be realized in a cost-effective and simple manner.

### Embodiment 2

The air water generator in Embodiment 2 is based on the air water generator of Embodiment 1, with the additional feature that multiple filters are installed in at least part of the flow path that supplies the condensed water stored in the water collection bottle to the cold water tank.

As already explained using FIG. 1, the air water generator according to the present invention is equipped with a flow path (flow path between the water collection bottle and the cold water tank 0101) for supplying the condensed water stored in the water collection bottle to the cold water tank. In this embodiment, multiple filters are installed in this flow path. The purpose of these filters is to purify the unfiltered drinking water stored in the water collection bottle before supplying it to the cold water tank, thereby obtaining uncontaminated drinking water.

The configuration of the air water generator in this embodiment is fundamentally the same as the configuration of the air water generator in Embodiment 1. However, in this embodiment, multiple filters are installed in at least part of the flow path that supplies the condensed water stored in the water collection bottle to the cold water tank.

The flow path in which these multiple filters are installed, referred to as the flow path between the water collection bottle and the cold water tank, is separate from the flow path described in Embodiment 1 that runs from the cold water tank to the water collection bottle (i.e., the “flow path between the cold water tank and the switching part” and the “flow path between the switching part and the water collection bottle”).

The filters installed in this flow path are primarily for purifying the condensed water. The main reason for installing multiple filters is that different types of filters have different functions and characteristics, so combining them allows for more effective water purification. From this perspective, it is preferable to combine multiple types of filters rather than using just one type. While the specific types of filters are not limited, examples include activated carbon filters, reverse osmosis (RO) membrane filters, biomineral filters, ceramic filters, and ion exchange resin filters. A particularly preferred example is a combination of at least activated carbon filters, reverse osmosis membrane filters, and biomineral filters. This example will be described later in another embodiment (refer to Embodiment 3).

With the invention of this embodiment, the drinking water stored in the cold water tank is pre-purified through multiple filters, allowing the invention to more effectively achieve the goal of ensuring that the drinking water ultimately discharged is as uncontaminated as possible.

### Embodiment 3

The air water generator of Embodiment 3 is based on the air water generator of Embodiment 2, with the additional feature that the multiple filters include at least an activated carbon filter, a reverse osmosis (RO) membrane filter, and a biomineral filter.

The configuration of the air water generator in this embodiment is fundamentally the same as the configuration of the air water generator in Embodiment 2. However, in this embodiment, the multiple filters include at least an activated carbon filter, a reverse osmosis membrane filter, and a biomineral filter.

An activated carbon filter is a filter that uses activated carbon (a porous carbon substance made from materials such as coconut shells or coal, which has been chemically or physically treated to enhance its adsorption efficiency). Activated carbon has excellent removal capabilities for various odors, such as chlorine in water, and the activated carbon filter is a filter with a high water purification capacity. Additionally, activated carbon filters are easy to shape and inexpensive. However, they have a relatively short lifespan, and replacement is required approximately once a year.

A reverse osmosis (RO) membrane filter is a filter that uses a membrane through which water molecules pass, but impurities do not, based on the principle of reverse osmosis. The pores in the membrane are extremely fine, approximately 0.0001 micrometers, which allows only water molecules to pass through, providing an extremely high level of impurity removal. Typically, a pump is used to pressurize the water at around 0.4 to 1.2 MPa to push it through the membrane. However, due to the extremely small size of the membrane's pores, there are certain issues, such as a limited flow rate per unit of time and the time it takes for the water to pass through. Additionally, the cost of applying the necessary high pressure for reverse osmosis is another concern. Moreover, because of the highly fine pores, not only harmful substances but also beneficial minerals are removed.

A biomineral filter is a filter that contains biominerals (a general term for inorganic compounds formed by living organisms). The purpose of this filter is to not only remove impurities and harmful substances but also to replenish minerals in the drinking water. Ideally, drinking water should be both delicious and beneficial to health, and thus it is desirable for it to contain the right types and amounts of minerals. However, since the air water generator in this embodiment includes a reverse osmosis membrane filter, most minerals are removed at that stage. Therefore, by adding a biomineral filter, minerals can be replenished in the drinking water. It is preferable that the biomineral filter is placed downstream of the reverse osmosis membrane filter, closer to the cold water tank, in the flow path between the water collection bottle and the cold water tank. There is no specific restriction on the types of biominerals in the filter, but it is preferable to use those that provide essential minerals necessary for human health. Essential minerals generally include 16 elements such as calcium (Ca), phosphorus (P), and potassium (K). Therefore, preferable biominerals are those rich in these elements, such as anorthite (CaAl₂Si₂O₈) and calcite (CaCO₃).

There is no strict limitation on the order in which the filters mentioned above are arranged, but it is preferable that they are arranged in the order of the activated carbon filter, reverse osmosis membrane filter, and then the biomineral filter. This is because the reverse osmosis membrane filter is relatively expensive, and has an extremely small pore size prone to clogging. Therefore, it is better to first use the relatively inexpensive activated carbon filter, which has larger pores, to remove most of the impurities and harmful substances before passing the water through the reverse osmosis membrane filter. Additionally, as explained above, the biomineral filter should be placed downstream of the reverse osmosis membrane filter for optimal performance.

With the invention of this embodiment, the drinking water stored in the cold water tank is pre-purified through filters, and by combining multiple types of filters, more effective water purification can be achieved. This allows the invention to better achieve the goal of ensuring that the drinking water ultimately discharged is as uncontaminated as possible.

### Embodiment 4

The air water generator of Embodiment 4 is based on the air water generator of Embodiment 1, with the additional feature that the switching part includes a three-way solenoid valve. This valve has an inlet connected to at least part of the flow path from the cold water tank, and two outlets: one connected to the flow path to the water discharge part and the other connected to the flow path to the water collection bottle.

The configuration of the air water generator in this embodiment is fundamentally the same as that of the air water generator in Embodiment 1. However, in the air water generator of Embodiment 4, the switching part includes a three-way solenoid valve with an inlet connected to at least part of the flow path from the cold water tank and outlets connected to the flow path leading to the water discharge part and the flow path leading to the water collection bottle.

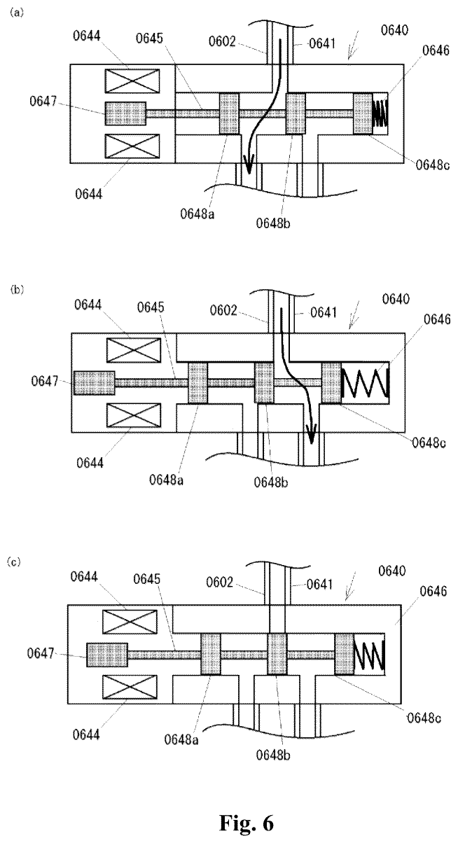

FIG. 6 shows an example of the configuration of the air water generator in Embodiment 4, specifically illustrating the structure of the three-way solenoid valve that constitutes the switching part. A three-way solenoid valve is a type of valve in which the switching method is electromagnetic (a solenoid valve). A solenoid valve is a device that can stop, allow, or change the direction of fluid flow by switching the current to a solenoid (electromagnet) on or off. In the example shown in the figure, the three-way solenoid valve has three connection ports to the flow paths in the main body 0640: the connection port 0641 for the flow path between the cold water tank and the switching part 0602, the connection port 0642 for the flow path between the switching part and the water collection bottle 0603, and the connection port 0643 for the flow path between the switching part and the water discharge part 0604. Inside the main body, besides the solenoid 0644, there is a plunger 0645 (shown in light gray) and a coil spring 0646. The plunger includes a core 0647 and three valve bodies 0648a, 0648b, and 0648c, and is able to move back and forth within the cylindrical main body. The valve body 0648c at the tip of the plunger is attached to a spring. In the example shown, when the solenoid is energized in the first direction, the drinking water in the flow path between the cold water tank and the switching part is drained to the water collection bottle, and when the solenoid is energized in the opposite direction (second energization), the water is supplied to the water discharge part. When no current is applied, the water remains in the flow path between the cold water tank and the switching part without being drained or supplied to either outlet.

FIG. 6(a) shows the state when the first current is applied to the solenoid. Here, the first current refers to the state where the direction of the magnetic field created by the solenoid causes the solenoid and the core to be attracted to each other. In this state, the core is attracted to the solenoid. At this time, the valve body attached to the plunger opens the connection port between the switching part and the flow path to the water collection bottle, and closes the connection port between the switching part and the flow path to the water discharge part. This can be achieved by pre-designing the attachment position of the valve body. This state is maintained for a predetermined time, during which the drinking water in the flow path between the cold water tank and the switching part is drained to the water collection bottle (the direction of the water flow is indicated by arrows).

Next, FIG. 6(b) shows the state after the predetermined time has passed and the direction of the current is reversed, with the second current now applied to the solenoid. Here, the second current refers to the state where the direction of the magnetic field created by the solenoid causes the solenoid and the core to repel each other. In this state, the core is repelled away from the solenoid. In the example shown in the figure, the core has slid to the left compared to its position in FIG. 6(a). The coil spring cannot compress further than it is in the state shown in FIG. 6(a), so the core cannot slide to the right. At this time, the valve body attached to the plunger opens the connection port between the switching part and the flow path to the water collection bottle, and closes the connection port between the switching part and the flow path to the water discharge part. This can be achieved by pre-designing the attachment position of the valve body.

Furthermore, FIG. 6(c) shows the state when water discharge is completed and the current has been turned off. In this state, the electromagnetic force of the solenoid is no longer active, so the coil spring, which was stretched during the second current and caused the core to slide left, returns to its natural state without any tension. Therefore, the position of the core has slid slightly to the right compared to the second current state shown in FIG. 6(b). At this time, the valve body attached to the plunger closes both the connection port between the switching part and the flow path to the water collection bottle, and the connection port between the switching part and the flow path to the water discharge part. This can be achieved by pre-designing the attachment position of the valve body.

### Embodiment 5

The atmospheric water generator of Embodiment 5 is primarily based on the atmospheric water generator of Embodiment 1, but further includes a control unit including at least a CPU, a main memory, non-volatile memory, and input/output interfaces.

The configuration of the atmospheric water generator in this embodiment is generally the same as that of the atmospheric water generator in Embodiment 1. However, in this embodiment, the control unit includes a control board that includes at least a CPU, main memory, non-volatile memory, and input/output interfaces.

In this embodiment, the control board refers to the hardware that executes the switching control program, comprising electronic circuits connecting the CPU, main memory, non-volatile memory, and input/output interfaces via bus lines. This control board has the advantage of being able to be mass-produced at a low cost. The CPU, main memory, non-volatile memory, and input/output interfaces are configured as described in Embodiment 1.

With the invention of this embodiment, it is possible to ensure that drinking water stored in the flow path between the water tank and the water outlet, which may be contaminated due to bacterial growth, is not discharged as-is. Instead, only drinking water that is as uncontaminated as possible is discharged. Additionally, this can be achieved using a simple and cost-effective method, thus enabling the provision of an affordable atmospheric water generator.

### Embodiment 6

The atmospheric water generator of Embodiment 6 is primarily based on the atmospheric water generator of Embodiment 1, but further includes a water purification filter installed in at least part of the water flow path between the cold water tank and the switching unit.

The configuration of the atmospheric water generator in this embodiment is generally the same as that of the atmospheric water generator in Embodiment 1. However, in this embodiment, at least part of the water flow path between the cold water tank and the switching unit includes a water purification filter.

The purpose of installing a water purification filter in at least part of the water flow path from the cold water tank to the switching unit is as follows. Specifically, during water discharge, the drinking water retained in the flow path between the cold water tank and the switching unit is first drained to the collection bottle, and only drinking water that has been supplemented with newly supplied water from the cold water tank, ensuring minimal contamination, is discharged from the discharge unit. Therefore, in the original invention, installing a water purification filter in at least part of the water flow path between the cold water tank and the switching unit is not essential. However, there is a possibility that impurities or bacteria attached to the inner walls of the flow path between the cold water tank and the switching unit are not drained during discharge and might mix with the drinking water that is sent to the discharge unit after the switch, leading to contamination. Thus, as a more optimal configuration considering such possibilities, the objective of this embodiment is to minimize the risk of impurities or bacteria mixing into the drinking water sent to the discharge unit by installing a water purification filter in at least part of the water flow path between the cold water tank and the switching unit.

The specific position for installing the water purification filter should be appropriately designed, but given the potential for impurities or bacteria attached to the portion of the inner wall of the flow path closest to the switching unit to mix with the water during discharge, it is preferable for the filter to be installed at the end of the flow path near the switching unit.

As for the specific type of water purification filter, the same types of filters mentioned in Embodiment 2 can be used.

With the invention of this embodiment, it is possible to minimize the risk of impurities or bacteria mixing with the drinking water sent to the discharge unit after switching. This ensures that only drinking water with minimal contamination is discharged, and this can be achieved using a cost-effective and simple method. Thus, the invention's objective of providing an affordable atmospheric water generator is better realized.

### Embodiment 7

The atmospheric water generator of Embodiment 7 is primarily based on the atmospheric water generator of Embodiment 2, but further includes a structure where the collection bottle and multiple filters can be inserted and removed from the front of the water generator housing.

The configuration of the atmospheric water generator in this embodiment is fundamentally the same as that of the atmospheric water generator in Embodiment 2. However, in addition to that, in this embodiment, the collection bottle and multiple filters are designed to be inserted and removed from the front of the water generator housing.

Since the collection bottle is meant to store unpurified condensation water and potentially contaminated drinking water that is drained via the switching unit before discharge, it needs to be regularly replaced or cleaned. The same applies to the multiple filters installed in the flow path between the collection bottle and the cold water tank, which circulate the condensation water and other liquids.

The objective of this embodiment is to make it easier to perform such replacement or cleaning by enabling the collection bottle and multiple filters to be inserted and removed from the front of the water generator housing. To achieve this, for example, a configuration could be adopted in which a door is installed on the front of the section of the water generator housing where the collection bottle and multiple filters are located, and these components are designed to be easily attachable and detachable.

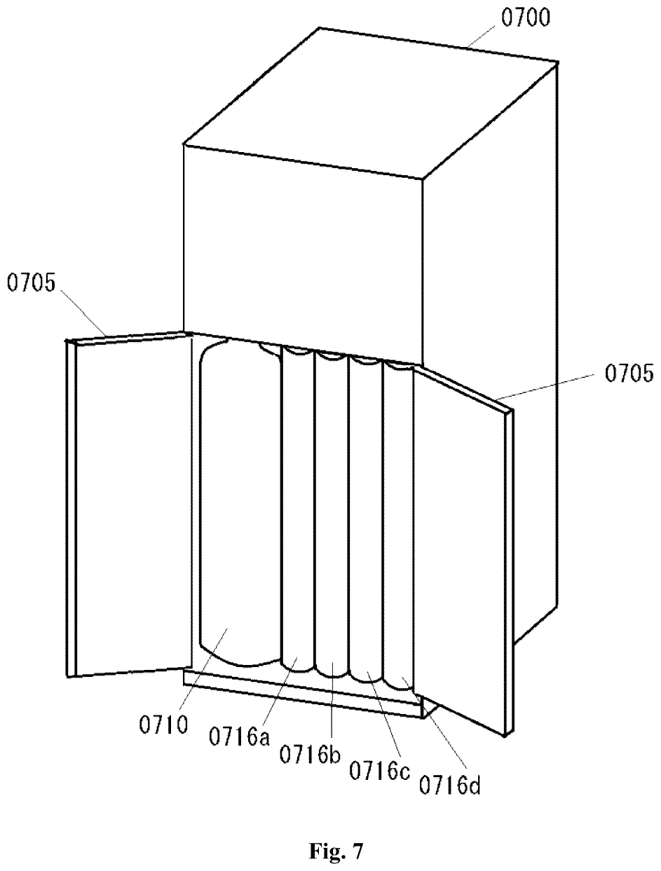

FIG. 7 shows an example of the exterior of the atmospheric water generator in Embodiment 6, where the collection bottle (0710) and multiple filters (0711-0714) are designed to be inserted and removed from the front of the water generator housing (0700). To achieve this, a hinged door (0705) is installed on the front of the section where the collection bottle and multiple filters are housed. In this case, the front door could be made transparent to easily check the level of contamination of the collection bottle and filters even with the door closed. Although not shown in the figure, the front upper part of the housing usually has the water outlet of the discharge unit.

To maintain the convenience of the atmospheric water generator, it is preferable to have multiple collection bottles that can either be disposable or swapped out while one bottle is being cleaned.

As for the multiple filters, it is desirable to use a cartridge type that can be easily attached and detached, with multiple disposable filters prepared for use as needed.

With the invention of this embodiment, the collection bottle and multiple filters can be inserted and removed from the front of the water generator housing, facilitating easier replacement and maintenance. As a result, the atmospheric water generator can provide drinking water with minimal contamination, offering an affordable and simple solution that aligns with the objectives of this invention.

### Embodiment 8

The atmospheric water generator in Embodiment 8 is based on the atmospheric water generator from Embodiment 6 and further incorporates a purification filter comprising at least one of the following: activated carbon filter, filtration membrane, ceramic filter, ion-exchange resin filter, or reverse osmosis membrane filter.

The structure of the atmospheric water generator in this embodiment is generally the same as that of the atmospheric water generator in Embodiment 6. However, in this embodiment, the purification filter is composed of at least one or more of the following: activated carbon filter, filtration membrane filter, ceramic filter, ion-exchange resin filter, or reverse osmosis membrane filter.

The purification filter described here is installed in the water flow path between the cold water tank and the switching unit. The main reason for providing multiple filters, similar to the reasoning in Embodiment 2, is that different types of filters have varying functions and characteristics, allowing for more effective purification when combined. Therefore, combining multiple types of filters is preferable over using a single type. From this perspective, the filters in this embodiment are composed of at least one or more of the following: activated carbon filter, filtration membrane filter, ceramic filter, ion-exchange resin filter, or reverse osmosis membrane filter. The features of the activated carbon filter and reverse osmosis membrane filter have already been described in Embodiment 3.

A filtration membrane filter is a filter made of a filtration membrane, and depending on the pore size, it is classified as a coarse filtration membrane filter (pore size greater than approximately 10 micrometers), a microfiltration membrane filter (pore size between approximately 0.05 micrometers and 10 micrometers), or an ultrafiltration membrane filter (pore size between approximately 0.001 micrometers and 0.05 micrometers). The smaller the pore size, the finer the particles or impurities it can capture. For example, a microfiltration membrane filter can capture microorganisms such as yeast and E. coli, but it allows proteins and viruses to pass through. An ultrafiltration membrane filter with smaller pore size can also capture proteins and viruses.

A ceramic filter is a filter made from ceramic material, which is characterized by its excellent durability and the ability to be reused repeatedly through cleaning and firing processes.

An ion exchange resin filter is a filter made from ion exchange resin (synthetic resin with ion exchange groups) and is capable of removing impurities in drinking water by capturing the ions of these impurities and releasing the ions that the resin contains in exchange.

The invention of this embodiment allows for the minimization of the risk that impurities and bacteria may be mixed into the drinking water discharged to the dispensing unit after switching, thus enabling the discharge of drinking water that is as free from contamination as possible. This realization can be achieved in a cost-effective and straightforward manner, aligning with the objectives of this invention.

### Embodiment 9

The atmospheric water generator of Embodiment 9 is based on the atmospheric water generator of Embodiment 1, and it further features a hot water tank that produces and stores warm water along at least a part of the water flow path from the cold water tank to the switching unit.

The structure of the atmospheric water generator in this embodiment is fundamentally consistent with the structure of the atmospheric water generator in Embodiment 1. However, in addition, this atmospheric water generator is equipped with a hot water tank that produces and stores warm water along at least a part of the water flow path from the cold water tank to the switching unit.

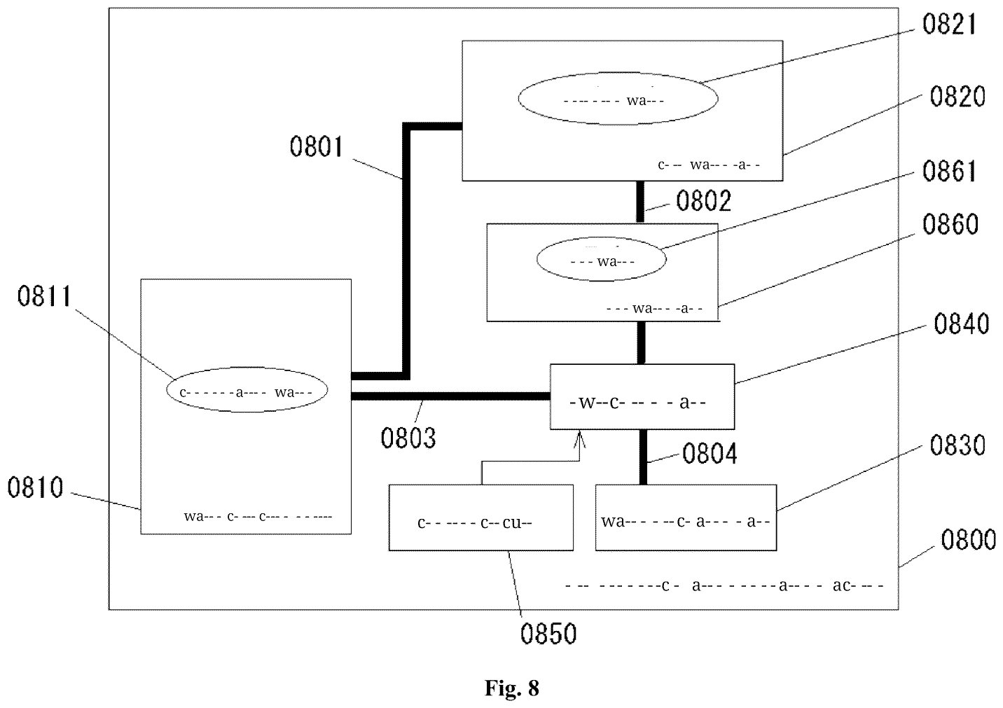

FIG. 8 shows an example of the structure of the atmospheric water generator in Embodiment 9 as a functional block diagram, illustrating an example where a hot water tank 0860 is included in the water flow path between the cold water tank and the switching unit. This hot water tank stores warm water heated by a heater located within the tank, for example. This configuration allows for the discharge of not only cold water but also warm water, thereby enhancing the convenience of the atmospheric water generator. Furthermore, circulating the warm water from the hot water tank through the water flow path between the cold water tank and the switching unit enables sterilization within that path, allowing for the more effective realization of the objective of discharging drinking water that is as free from contamination as possible.

The invention of this embodiment allows for the discharge of not only cold water but also warm water, thereby enhancing the convenience of the atmospheric water generator. Additionally, it minimizes the risk of impurities and bacteria being mixed into the drinking water discharged to the dispensing unit after switching. Thus, it becomes possible to provide an atmospheric water generator that discharges drinking water that is as free from contamination as possible, effectively achieving the objectives of this invention.

The atmospheric water generator in Embodiment 10 is based on the atmospheric water generator in Embodiment 1, while also being characterized by the inclusion of a UV lamp that irradiates the drinking water stored in the cold water tank with ultraviolet light.

The structure of the atmospheric water generator in this embodiment is fundamentally consistent with the structure of the atmospheric water generator in Embodiment 1. However, in addition, this atmospheric water generator is equipped with a UV lamp that irradiates the drinking water stored in the cold water tank with ultraviolet light. This configuration enables the sterilization of the drinking water stored in the cold water tank by the UV lamp.

The invention of this embodiment allows for the minimization of the risk of impurities and bacteria being mixed into the drinking water discharged to the dispensing unit after switching. This facilitates the provision of an atmospheric water generator that discharges drinking water that is as free from contamination as possible, effectively achieving the objectives of this invention.

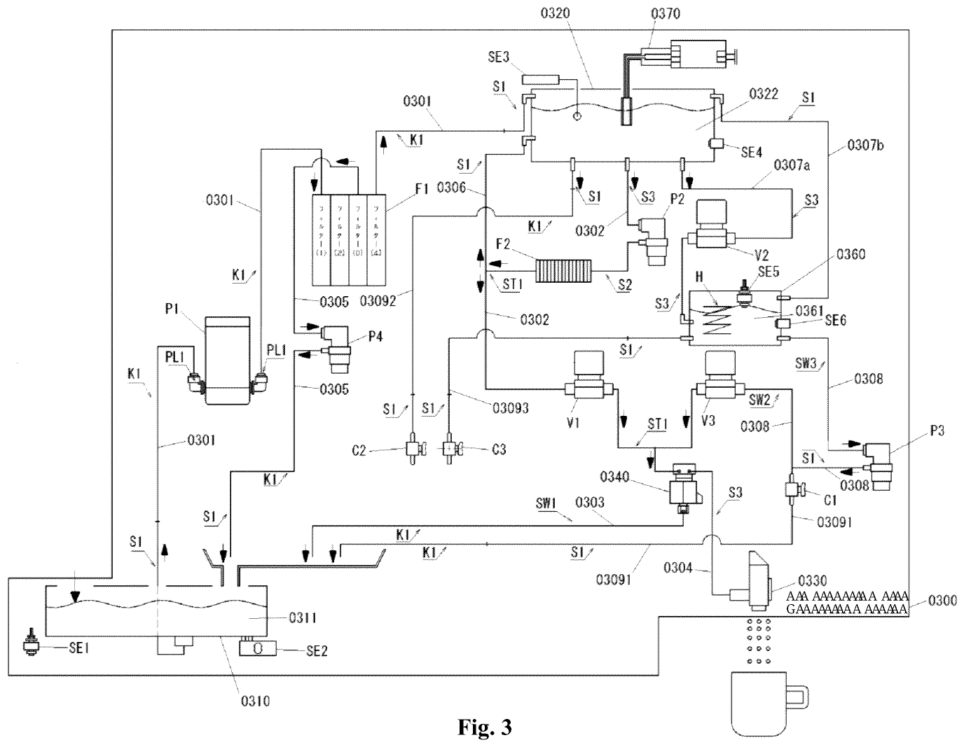

FIG. 3 is a diagram for explaining an embodiment of the atmospheric water generator according to the present invention. Below, using the same figure, an embodiment of the atmospheric water generator 0300 according to the present invention will be described in accordance with the processing order for condensed water and drinking water.

As shown in the lower left of the figure, first, condensed water 0311 made from air is collected in the collection bottle 0310. The capacity of the collection bottle in this embodiment is 1.5 liters. In the example shown in the figure, the collection bottle is equipped with a water level sensor SE1 and a weight sensor SE2 to prevent leakage.

The condensed water collected in the collection bottle is sent to the cold water tank 0320 (shown in the upper right of the figure) via the water flow path 0301 between the collection bottle and the cold water tank. The water flow path between the collection bottle and the cold water tank in this embodiment is formed by joining a silicone hose (S1) (the material and inner diameter of the hose are indicated in parentheses; hereafter the same applies, and “S1” indicates a silicone hose with an inner diameter of 4 millimeters) and a rigid hose (K1) (a rigid hose with an inner diameter of 4 millimeters). The intake of condensed water into the water flow path is performed using a pump P1 provided on the water flow path.

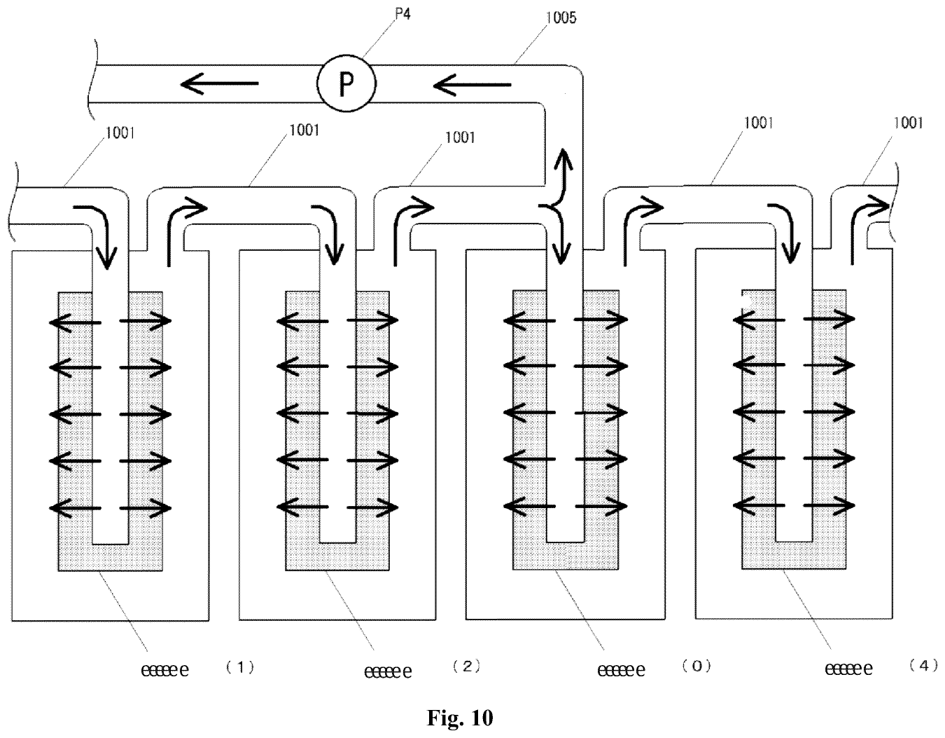

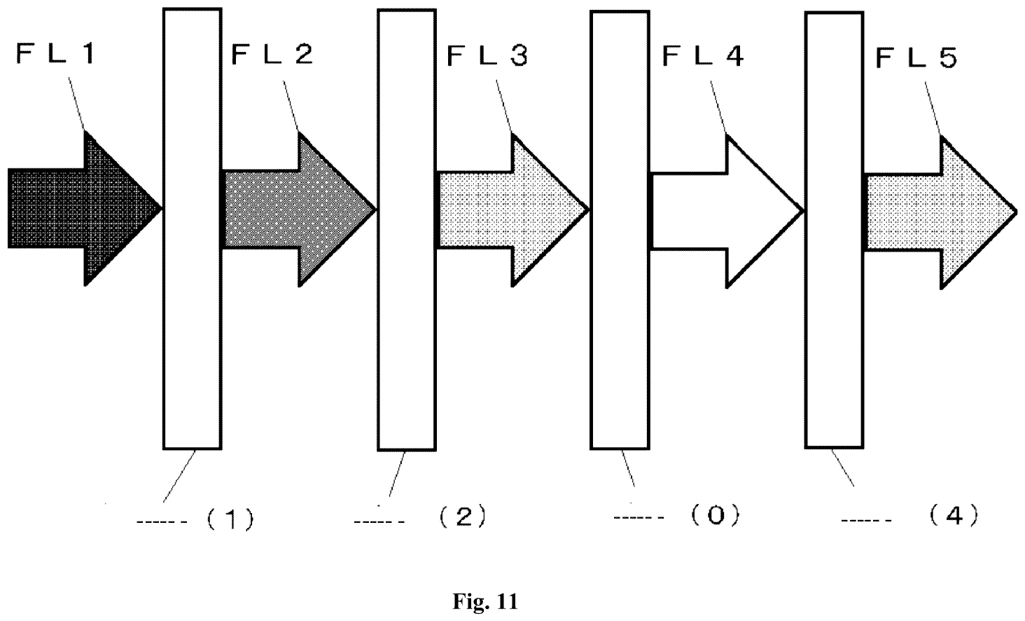

Additionally, a water purification filter F1 is provided in the water flow path between the collection bottle and the cold water tank. The figure shows an example where four water purification filters (Filter (1), Filter (2), Filter (0), Filter (4)) are provided. It is preferable that these filters are selected from multiple types, such as a filtering filter, an activated carbon filter, a reverse osmosis membrane filter, a biomineral filter, a ceramic filter, and an ion exchange resin filter. The figure sequentially shows examples of a filtering filter, an activated carbon filter, a reverse osmosis membrane filter, and a biomineral filter (this is also the case in the subsequent FIGS. 10 and 11).

FIG. 10 is a conceptual diagram illustrating an example of the structure of the water purification filter provided in the water flow path 1001 between the collection bottle and the cold water tank (note that this is a conceptual diagram and does not necessarily represent the actual shape). In the example shown in the figure, there are four water purification filters (Filter (1), Filter (2), Filter (0), Filter (4)), each containing a filter medium (filter body) 10 housed within a cylindrical cartridge 10. These water purification filters are interconnected in the water flow path 1001 between the collection bottle and the cold water tank, allowing the condensed water to be purified as it sequentially passes through these filters.

FIG. 11 is a conceptual diagram showing the state in which the condensed water is gradually purified as it sequentially passes through the multiple interconnected water purification filters. The arrows FL1-4 indicate the flow of condensed water, and the shading of the colors represents the amount of impurities (darker colors indicate a higher amount of impurities). It is shown that the purification process progresses as the condensed water passes through Filter (1), Filter (2), and Filter (0) in sequence. In this context, Filters (1), (2), and (0) shown in the figure represent a filtering filter, an activated carbon filter, and a reverse osmosis membrane filter, respectively, as described above. Additionally, Filter (4) represents a biomineral filter. This is because the reverse osmosis membrane filter almost completely removes impurities, including minerals, so the biomineral filter is placed afterward to add minerals back into the water.

Returning to FIG. 10, the water purification filter can be designed such that the cartridge containing the filter medium is divided into two compartments. The condensed water first sent to the inner first compartment passes through the filter medium and is then sent to the outer second compartment. It is further sent to the inner first compartment of the next water purification filter via the water flow path between the collection bottle and the cold water tank, repeating the same process afterward. This purified water is sent to the cold water tank, ensuring that the cold water tank stores drinking water that is free from contamination.

It is desirable to drain a portion of the water sent to the water purification filter (0), which is a reverse osmosis membrane filter. For this purpose, for example, a water flow path 1005 can be established between the reverse osmosis membrane filter and the collection bottle. Using a pump P4 provided in this water flow path, a portion of the water before passing through the filter medium of the reverse osmosis membrane filter can be returned to the collection bottle side. This configuration considers that, due to the nature of reverse osmosis membranes, it is necessary to apply water pressure to reverse osmosis the water. Furthermore, the pore size of the filter medium of the reverse osmosis membrane filter is extremely fine compared to other types of water purification filters (the pore size of the reverse osmosis membrane filter is approximately 0.0001 micrometers, while the pore size of a biomineral filter, for example, is about 0.4 micrometers). In other words, condensed water is sent from the collection bottle through the water flow path between the collection bottle and the cold water tank using a pump at a constant pressure and flow rate. During this process, the condensed water first passes sequentially through the filtration filter and the activated carbon filter, eventually reaching the reverse osmosis membrane filter. However, because the pore size of the filter medium in the reverse osmosis membrane filter is very fine, the flow rate that can pass through in a unit time is small. As a result, the condensed water cannot pass through the filter medium of the reverse osmosis membrane filter at the previous pace (flow rate), and the condensed water that has become stagnant in front of the filter medium may try to flow back, potentially obstructing smooth water purification. Therefore, as mentioned above, a water flow path 1005 is established between the reverse osmosis membrane filter and the collection bottle to prevent the stagnation of water.

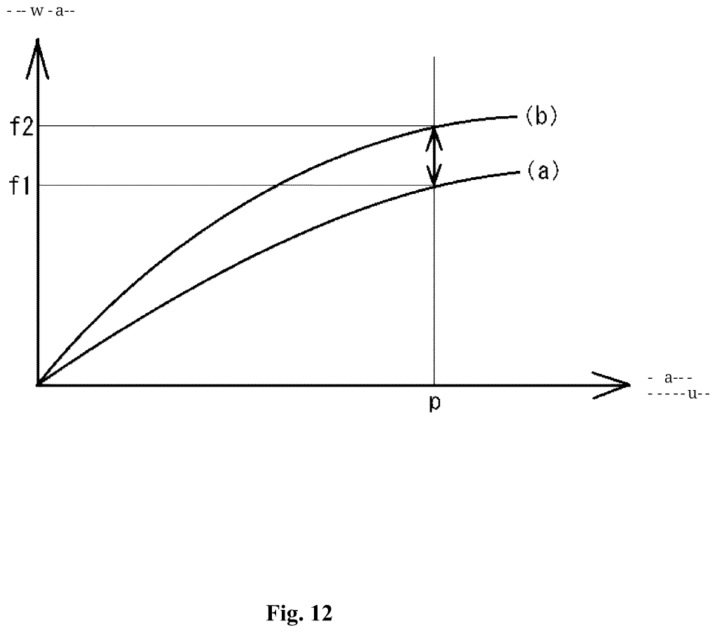

FIG. 12 shows a conceptual diagram representing the relationship between water flow rate and water pressure in the water purification filter (this is merely a conceptual diagram and is qualitative in nature). Generally, as water pressure increases, the flow rate also increases; however, the specific numerical values in this relationship differ based on the type of filter. Among the two curves presented, (a) represents the relationship in a reverse osmosis membrane filter, while (b) illustrates the relationship in an activated carbon filter as an example of another filter. In the figure, the flow rate (the flow rate that can pass through the filter medium per unit time) f1 in the reverse osmosis membrane filter at the same water pressure p is shown to be lower than the flow rate f2 in the activated carbon filter. This indicates that the water that passes through the activated carbon filter and reaches the reverse osmosis membrane filter (in front of the filter medium) at the same water pressure tends to stagnate there.

Returning to FIG. 3, the cold water tank 0320 stores water sent from the collection bottle 0310 as drinking water 0322. The capacity of the cold water tank shown in the figure is 12 liters. The cold water tank shown in the figure is equipped with a water level sensor SE3 and a water temperature sensor SE4 for temperature management. Additionally, the cold water tank shown in the figure is provided with a UV lamp 0370 for sterilizing the drinking water in the tank.

In the example shown in the figure, a water flow path 03092 is established from the cold water tank 0320 to the manual tap C2 for discharging cold water. This water flow path is set up for discharging cold water during power outages. Water discharge can be performed by the user manually operating the cold water manual tap to open it. In this case, water will be discharged from a different outlet than the normal discharge part 0330.

The drinking water in the cold water tank is sent to the switching part 0340 via the water flow path 0302 between the cold water tank and the switching part. The water flow path between the cold water tank and the switching part includes a silicone hose (S3) (with an inner diameter of 11 millimeters), a silicone hose (S2) (with an inner diameter of 9 millimeters), and a T-shaped silicone hose (ST1) (with an inner diameter of 11 millimeters). The section using the T-shaped hose allows some of the drinking water in the water flow path between the cold water tank and the switching part to be returned to the cold water tank through another water flow path 0306 without being sent to the switching part. In the example shown in the figure, these deliveries are also performed using a pump P2 provided on the path. Furthermore, a filter F2 for purification is also provided along this path. Additionally, a supply valve (check valve) V1 is installed on this path to prevent backflow of water into the cold water tank.

The atmospheric water generator in this embodiment is equipped with a hot water tank 0360, as shown in the figure, enabling it to provide both cold and hot water to users. The hot water tank is equipped with a heater H, and the drinking water sent from the cold water tank is heated by this heater and stored in the hot water tank. The capacity of the hot water tank in the example shown in the figure is 2 liters. This hot water tank is also provided with a water level sensor SE5 and a water temperature sensor SE6.

Thus, with the addition of the hot water tank in this embodiment, two water flow paths (water flow paths between the cold water tank and the hot water tank) 0307a and 0307b are established, along with a water flow path (water flow path between the hot water tank and the switching part) 0308 leading from the hot water tank to the switching part, separate from the previously mentioned water flow path between the cold water tank and the switching part.

Of the two water flow paths between the cold water tank and the hot water tank, one flow path 0307a is for sending water from the cold water tank to the hot water tank. Water sent from the cold water tank through the supply valve V2 to the hot water tank is heated in the hot water tank before being provided to the user. This flow path uses a silicone hose (S1). On the other hand, the other water flow path 0307b between the cold water tank and the hot water tank is designed to return some of the water in the hot water tank to the cold water tank when the hot water tank is about to overflow. This flow path uses a silicone hose (S3).

The water flow path 0308 between the hot water tank and the switching part is a flow path for sending hot water from the hot water tank 0360 to the switching part 0340. This path uses a silicone hose (S1). The supply of drinking water from the hot water tank to the switching part is also carried out using pump P3, similar to the previously described supply of drinking water from the cold water tank to the switching part. Additionally, as shown in the figure, a supply valve (check valve) V3 may be provided on the water flow path between the hot water tank and the switching part to prevent hot water from flowing back to the cold water tank, as previously mentioned for cold water.

Typically, hot water contains bubbles generated by heating (steam) and air that has entered during the operation of the pump (hereinafter referred to as “air, etc.”). When trying to pump hot water containing such air, a phenomenon occurs where the flow rate and water pressure in the flow path are insufficient (commonly known as “air locking”), causing the pump to malfunction. Therefore, as shown in the figure, a water flow path 0309 that branches off from the water flow path 0308 between the hot water tank and the switching part to the collection bottle is provided, with a tap C1 installed near the branching point on this flow path. This tap is usually kept closed and is opened when the water in the hot water tank boils (at which time the supply valve V3 closes), allowing the water containing steam in the flow path to return to the collection bottle 0310, preventing water with steam from accumulating in the water flow path 0308 between the hot water tank and the switching part. After this process is complete, the tap can be closed again, returning to the normal state. These processes may be configured to automatically open and close the supply valve and the tap when the sensor detects that the water in the hot water tank has boiled. Under normal conditions, that is, when the tap is closed, if there is a start of hot water discharge at the discharge part, the hot water will flow towards the switching part without flowing toward the collection bottle.

In this example, similar to the case of cold water, a water flow path 0309 for hot water discharge from the hot water tank 0360 to the manual tap C3 for hot water is provided. This flow path is established for hot water discharge during a power outage. The discharge can be performed by the user manually operating the hot water tap, and it is discharged from a different outlet than the regular discharge part 0330, just like the previously described cold water.

The cold water sent from the cold water tank through the water flow path between the cold water tank and the switching part (or the hot water sent from the hot water tank through the water flow path between the hot water tank and the switching part) is switched at the switching part 0340, allowing it to drain to the collection bottle side for a predetermined time before being sent to the discharge part 0330. In this example, the switching part is a three-way valve. This switching is controlled by a control unit, which is not illustrated in the diagram.

After the cold water that has been drained to the collection bottle side for a predetermined time at the switching part, drinking water within the water flow path between the cold water tank and the switching part (or the hot water tank and the switching part) and, in addition to these, drinking water in the cold water tank or hot water tank is sent to the discharge part 0330 via the water flow path 0304 between the switching part and the discharge part, where it is discharged for drinking. The water flow path between the switching part and the discharge part includes a silicone hose (ST3) with an inner diameter of 11 millimeters.

1. An air water generator that produces drinking water from air, the air water generator comprising:
a water collection bottle that stores water condensed from air;
a cold water tank that stores drinking water;
a water discharge part that discharges the drinking water from the generator;
a switching part that switches a flow path of the drinking water supplied from the cold water tank, wherein the flow path connects the cold water tank to the water discharge part and the water collection bottle through the switching part; and
a control unit that controls the switching part;
wherein the control unit, during water discharge, drains at least part of the drinking water stored in at least part of the flow path from the cold water tank to the switching part into the water collection bottle for a predetermined time, and after the predetermined time has elapsed, controls the switching part to discharge drinking water from the water discharge part.

2. The air water generator of claim 1, wherein a plurality of filters are provided in at least part of the flow path that supplies the condensed water stored in the water collection bottle to the cold water tank.

3. The air water generator of claim 2, wherein the plurality of filters include any one of an activated carbon filter, a reverse osmosis membrane filter, and a bio-mineral filter.

4. The air water generator of claim 1, wherein the switching part includes a three-way solenoid valve, with at least part of the flow path connection from the cold water tank as an inlet, a flow path connection part connected to the water discharge part, and a flow path connection part connected to the water collection bottle as outlets.

5. The air water generator of claim 1, wherein the control unit includes a control board composed of at least a CPU, main memory, non-volatile memory, and an input/output interface.

6. The air water generator of claim 1, wherein a water purification filter is provided in at least part of the flow path from the cold water tank to the switching part.

7. The air water generator of claim 2, wherein the water collection bottle and the plurality of filters are configured to be removable from the front of the machine housing.

8. The air water generator of claim 6, wherein the water purification filter includes at least one or more of an activated carbon filter, filtration membrane filter, ceramic filter, ion exchange resin filter, or reverse osmosis membrane filter.

9. The air water generator of claim 1, wherein a hot water tank for producing and storing hot water by heating at least part of the flow path from the cold water tank to the switching part is provided.

10. The air water generator of claim 1, wherein an ultraviolet lamp is provided to irradiate the drinking water stored in the cold water tank.

11. A method of providing drinking water from an air water generator, the method comprising:
storing water condensed from air in a water collection bottle;
transferring the water from the water collection bottle to a cold water tank to be stored as drinking water;
discharging drinking water from a water discharge part, wherein discharging the drinking water includes:
controlling, by a control unit, a switching part to switch a flow path of the drinking water, wherein the flow path connects the cold water tank to the water discharge part and the water collection bottle through the switching part, wherein during water discharge:
the control unit controls the switching part to drain at least part of the drinking water stored in at least part of the flow path from the cold water tank to the switching part into the water collection bottle for a predetermined time and after the predetermined time has elapsed, controls the switching part to discharge drinking water from the water discharge part.

12. The method of claim 11, wherein a plurality of filters are provided in at least part of the flow path that supplies the condensed water stored in the water collection bottle to the cold water tank, and the method further comprises filtering the water which is transferred between the water collection bottle and the cold water tank.

13. The method of claim 12, wherein the plurality of filters include any one of an activated carbon filter, a reverse osmosis membrane filter, and a bio-mineral filter.

14. The method of claim 11, wherein the switching part includes a three-way solenoid valve, with at least part of the flow path connection from the cold water tank as an inlet, a flow path connection part connected to the water discharge part, and a flow path connection part connected to the water collection bottle as outlets.

15. The method of claim 11, wherein the control unit includes a control board composed of at least a CPU, main memory, non-volatile memory, and an input/output interface.

16. The method of claim 11, wherein a water purification filter is provided in at least part of the flow path from the cold water tank to the switching part, and wherein the method further comprises, during water discharge, filtering the drinking water which passes through the flow path between the cold water tank and the switching part.

17. The method of claim 16, wherein the water purification filter includes at least one or more of an activated carbon filter, filtration membrane filter, ceramic filter, ion exchange resin filter, or reverse osmosis membrane filter.

18. The method of claim 1, wherein a heater is provided to heat at least part of the flow path from the cold water tank to the switching part, wherein the method further comprises, during water discharge, heating the drinking water in the flow path between the cold water tank and the switching part.

19. The method of claim 1, wherein an ultraviolet lamp is provided to irradiate the drinking water stored in the cold water tank, wherein the method further includes irradiating the drinking water in the cold water tank.

20. The method of claim 1, further comprising condensing water from the air by at least one of a refrigeration technique and an adsorption technique.
